(19) United States
(12) Patent Application Publication
(10) Pub. No.: US 2014/0312087 A1
(43) Pub. Date: Oct. 23, 2014

(54) DEVICE FOR SECURING A LONG GUN TO THE INSIDE OF A VEHICLE DOOR

(71) Applicants: Mark Malingen, Detroit Lake, MN (US); Jay Christenson, Moorhead, MN (US)

(72) Inventors: Mark Malingen, Detroit Lake, MN (US); Jay Christenson, Moorhead, MN (US)

(21) Appl. No.: 14/243,589

(22) Filed: Apr. 2, 2014

Related U.S. Application Data
(60) Provisional application No. 61/808,163, filed on Apr. 3, 2013.

(51) Int. Cl. B60R 7/14

(52) U.S. Cl. CPC B60R 7/14
USPC 224/539

(57) ABSTRACT

A long gun rack for holding long guns on the inside of a vehicle door. The rack contains four essential pieces, one which rests on the vehicle door handle, a second which rests on the vehicle door cubby slot, third and on the opposite side is a rest for the butt of the gun and fourth another rest for the arm of the gun. All pieces are rotatable and moveable to allow for adaptation to many vehicles and guns. The holder rests on the door in such a way as to require no hard fastening.

### BACKGROUND OF INVENTION

When hunting wild game, deer, ducks, geese, coyotes, or for Law enforcement and military personnel, it is desirable to easily locate and remove a rifle or shotgun (gun) from a vehicle usually a truck (vehicle). The present invention allows for a long gun to be mounted on the inside of a vehicle door, when the desired destination is reached the and the user exits the vehicle the gun is easily removed from the holder on the door before, during, or after the vehicle door is open.

Guns which are not fixedly connected to some portion of the vehicle present a particular safety hazard along with guns that are mounted in the so-called “window rack” that is used in pickup trucks and other cab vehicles. In placing a gun in a vehicle without support or placing a gun in a window rack, it is necessary that the muzzle be pointed into the cab or toward the person positioning the gun. When held in a window rack the gun is in a horizontal position and if advertently discharged could injure a passing motorist or be discharged into a building and the like.

Other racks have been proposed for carrying weapons in a vehicle. The most pertinent of which is Whittaker, U.S. Pat. No. 3,556,363. This patent overcame any of the prior art problems and consists of a two-piece rack for holding rifles, shotguns and the like. The rack contains a butt rest and a pivotal arm having an adjustable clamp, which clamp provides a means for holding the gun in a set position. The clamp has to be bolted into one of the holes along the length of the pivot arm depending upon the length of the gun being held. The clamp consists of a spring steel clip which, while functioning well, for its purposes has certain disadvantages. For example, a sudden jolt or other exertion of pressure on the clip can cause the gun to be released from the clip. The clip can also be “sprung” or otherwise lose its resiliency so that it cannot be used for its intended purpose. Additionally, it is well known that the circumference of a gun barrel may vary greatly according to the gun with most barrels varying in size from a 22 caliber rifle to a 12 gauge shotgun thereby making it impractical for one clip to universally accommodate all guns. This mount is also limited because it requires the small triangle door which was present on older model pickup.

U.S. Pat. No. 4,057,180 to Whittaker over comes some of the problems with the U.S. Pat. No. 3,556,363, but still relies on a semi-permanent mounting to the door structure through screws.

Prior art in this field:

U.S. Pat. No. 4,057,180 filed in 1975 describes a mount for the inside of a vehicle door.

U.S. Pat. No. 3,857,491 filed in 1973 describes a gun mount for the inside of the a vehicle.

The above prior patents along with several others describe various gun mounting devices however these all have limitations ranging from ease of installation to ease of gun mounting and removal.

### DRAWINGS OF THE INVENTION

FIG. 1 is an isometric view of the door mounting side of the long gun mount.

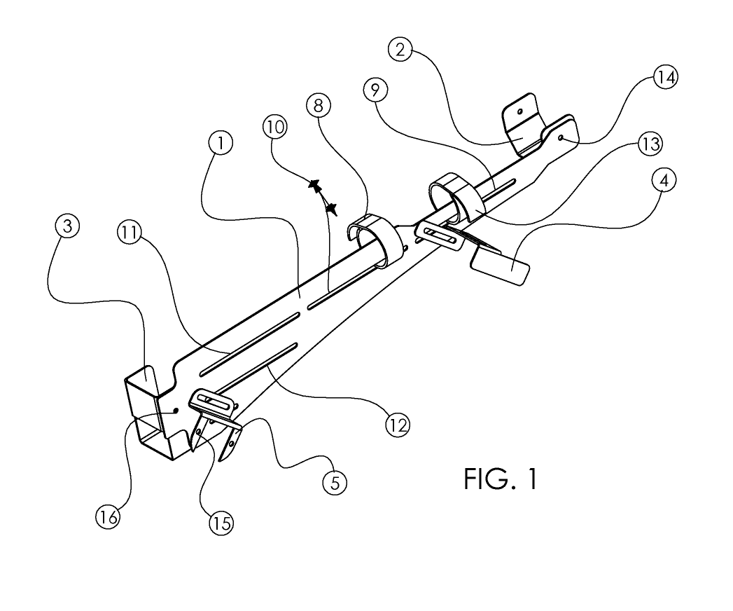

FIG. 2 is an isometric view of the rests for the long gun mount.

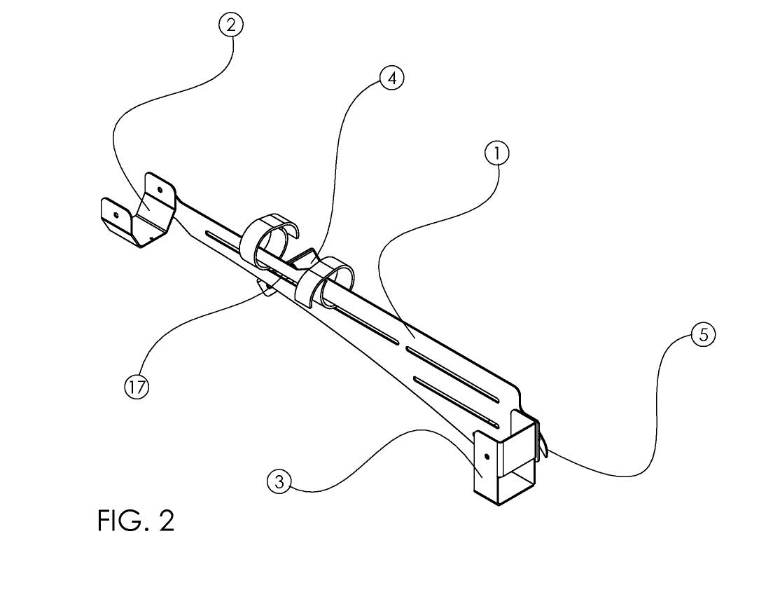

FIG. 3 is a view of the long gun mount in place on a vehicle door.

### DETAILED DESCRIPTION

Referring to the Drawings. One embodiment of our vehicle door long gun holder (holder) begins with an elongated thin of section of appropriate width, length and thickness made of ridged material 1 (long section). Extending away from the flat side of long section 1 are adjustable fasteners 4, 5 (fasteners or fastener) and on the opposite side from the fasteners 4, 5 on the of long section 1 and at opposite ends of the long section 1 are long gun rests 2, 3 (rests or rest). The fasteners 4, 5 and rests 2, 3 are attached through removable means such as screws or bolts so they can alternate sides of the long section depending if the passenger door or driver's door of the vehicle is being utilized. The length of the long section 1 depends on the application, however in this embodiment the long section 1 has linear slots 9,10,11,12 running lengthwise through the long section 1 allowing for the fasteners 4, 5 to slide or adjust along the length of the long section 1 making the fasteners 4, 5 sizable to many applications.

### The Gun Mounting Sections

In this embodiment at one end of the long section 1 is a “U” shaped hook rest 2 attached to the long section 1. The “U” rest 2 extends from the long section 1 like a cupped hand in which a gun arm 18 can be laid and is located on one end of the long section 1. The “U” rest 2 may be attached to long section 1 rigidly or through pivotal means such as a bolt, screw, or rivet (14).

At the opposite end of the long section 1 is the butt rest 3 for the gun butt (butt rest). The butt rest 3 is projected from the long section 1 on the same side as the “U” rest 2. The butt rest 3 may be attached to long section 1 rigidly or through pivotal means such as a bolt, screw, or rivet 16. In this embodiment the butt rest 3 is a flat piece of ridged material projected away from the flat side of long section 1 a distance suitable for the width of a gun butt 19 with the wide side of the flat piece facing the “U” rest 2, and a 90 degree bend toward the “U” rest 2 at the end of the butt rest 3.

Approximately in the center of the long section 1 is a flexible strap 8 which when closed is a loop and wraps around or is attached to the long section 1. This Flexible strap 8 can be opened, closed, or tightened using such means as Velcro® or snaps. Flexible strap 8 may attach to the long section 1 by any means but in this embodiment it is either hard fastened and cannot move or attached through sliding means either by being wrapped around the entire long section 1 or secured in one of the slots 9,10,11,12 therefore can be move back and forth along the length of long section 1.

Approximately half way between flexible strap 8 and the “U” rest 2 is another flexible strap 13 which wraps around the long section 1 and can be opened and closed, or tightened using such means as Velcro® or snaps. Flexible strap 13 may attach to the long section 1 by any means but in this embodiment it is either hard fastened and cannot move or attached through sliding means either by being wrapped around the entire long section 1 or secured in one of the slots 9,10,11,12 therefore can be adjusted the along the length of long section 1.

### The Door Fasteners

In this embodiment the holder has fasteners 4, 5 which project outwardly from the long section 1 opposite the “U” rest 2 and the butt rest 3. Fastener 4 is attached to slot 9 or slot 10 through sliding means such as an adjustable pin or screw allowing the fastener 4 to be adjusted to any position on slot 9 or slot 10. Additionally fastener 4 is attached to the appropriate slot 9, 10 by pivotal means such as a nut, bold, rivet, screw or pin 17, allowing it to rotate in relative to the long section 1. Fastener 4 in this embodiment, but not limited to, has a general shape of a flat ridged piece extending away from long section 1 approximately 5 to 12 cm then a 90 degree bend in the flat material for about 3 cm.

Fastener 5 is similar to fastener 4 but is attached to slot 11 or slot 12 allowing the fastener 5 to be adjusted to any position on slot 11 or slot 12. Additionally fastener 5 is attached to the appropriate slot 11, 12 by pivotal means such as a nut, bold, rivet, screw or pin 15, allowing it to rotate in relative to the long section 1. Fastener 5 in this embodiment, but not limited to, has a general shape of a flat ridged piece extending away from long section 1 approximately 3-5 cm then a 90 degree bend in the flat material for about 3 cm.

### Operation

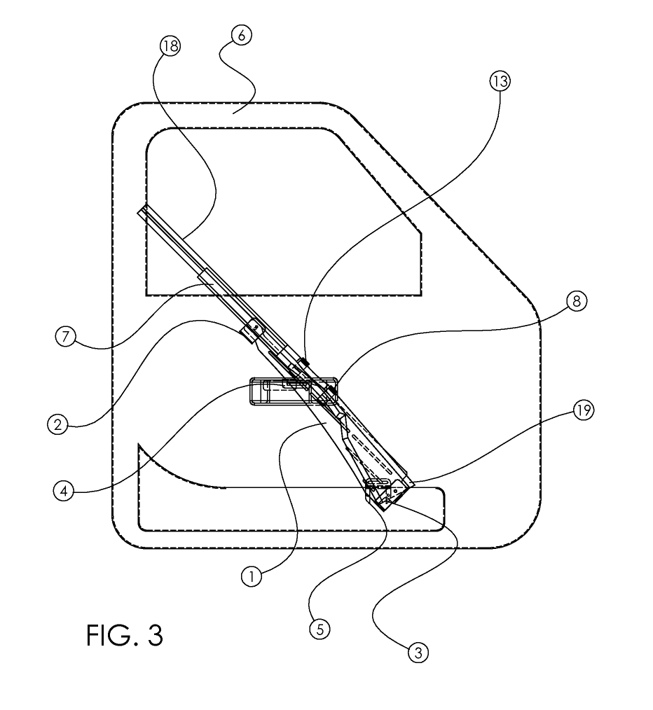

The holder is first attached to a vehicle door 6 by hooking fastener 4 inside the vehicle door handle 21 then hooking fastener 5 into the door cubby slot 20 so that the holder rests diagonally across the inside of the vehicle door 6. Next a long gun 7 is placed with the butt of the gun in the butt rest 3 and the arm of the gun 18 in the “U” rest 2. The gun 7 is now resting in the holder and is relatively secure, further security is obtained by wrapping flexible material 8 and flexible material 13 around the gun, the material being opened and closed or fastened and unfastened through means such as Velcro® or snaps, securing the gun to the holder. Now the gun 7 is secured to the door 6 of the vehicle and the door may be opened or closed, see FIG. 3.

All vehicle doors 6 are not identical, adjustments can be made. Fastener 5 may be pivoted around attachment 15 to allow for different angles when inserted in the cubby slot 20. Additionally fastener 5 may be slid for position along the length of slot 12 or repositioned by attaching to slot 11 and then adjusted along the length of slot 11. These adjustments allow for a wide variety of positions for fastener 5 to allow for different angles of the holder and different doors 6.

For the same reasons fastener 4 may be pivoted around attachment 17 to allow for different angles when inserted in the door handle 21. Additionally fastener 4 may be slid for position along the length of slot 9 or repositioned by attaching to slot 10 and then adjusted along the length of slot 10. These adjustments allow for a wide variety positioning fastener 4 to allow for different angles of the holder and different doors 6.

The flexible straps 8, 13 also can be slid the length of long section 1 to account for different guns 7 and door 6 configurations.

### Alternative Configurations

In one configuration of our holder the flexible strap 8 acts as a trigger guard by wrapping it around the position on the gun 7 where the trigger 22 is located.

In one embodiment of the invention the entire holder is rubber dip coated which will minimize damage to both guns and vehicles.

In one embodiment the long section 1 is simply a pole or a pipe whereas the rests 2, 3 are attached by a clamping means and can slide up and down or swivel around the long section 1 (pole). In this configuration the fasteners 4, 5 also can attach to the pole by clamping means and can swivel and slide up down and around the long section.

In one embodiment the long section 1 is simple a pole or a pipe. Located along the pole are two fasteners 4, 5 one of which rests on the vehicles door's handle 21 and the other fastener 5 rests on the lower cubby slot 20 of the vehicles door, facing away from the fasteners 4, 5 and attached to the pole are two rests 2, 3 for the arm of the long gun 18 and the butt 19 of the long gun 7, wrapped around or attached to the pole are multiple soft flexible straps 8, 13, the straps can be loops which open or close and secure to themselves by securing means. In this pole configuration all components attach to the pole through removable and slideable means, such as clamping each piece. This allows for almost infinite configurations depending on the application.

### Advantages

This invention overcomes problems with existing gun mount technology. U.S. Pat. No. 4,057,180 to Whittaker describes a gun mount for the inside of a vehicle door. This patent however requires the mount to be screwed to the vehicle door, thus preventing its easy installation and removal and damaging the door. Our holder simply rests within the existing structure of the vehicle door allowing easy installation and removal an no damage to the doors.

There are other gun/rifle/shotgun mounts for vehicles such as in U.S. Pat. No. 3,857,491 to Townsend. However most of these involved securing the gun behind the driver of the vehicle to either the ceiling or rear of the vehicle cab. The current invention allows the gun to be lifted from the mount as the driver or passenger exits the vehicle without point the gun into or at the other passenger.

It is an object of our long gun holder to provide a long gun holder wherein the holder can be easily inserted into a vehicle, and removed from the vehicle without any mounting screws (hard fastening), making for fast installation and removal. Additionally allowing for enough customization to fit various long guns and various vehicles.

The novel features of our holder both as to the manner of construction or organization as well as the operation thereof will be better understood with reference to the drawings. It is to be understood, however, that the description and drawings are for the purpose of illustration only and are not intended to be a definition as to the scope of this invention.

I claim:

1. A vehicle door long gun holder that rests diagonally on the inside of a vehicle door, comprising:
a) an elongated thin of section of ridged material of appropriate thickness, length and width,
b) located on one side of the elongated thin section and separated appropriately along its length are two fasteners one of which rests on the vehicle's door's handle and the other fastener rests on the lower cubby slot of the vehicle's door,
c) also on the elongated thin section but on the opposite side of the fasteners is a rest for the arm of the long gun and a rest for the butt of the long gun,
whereby a user can rest the long gun holder on the inside of a vehicle door without hard fastening the holder to the door.

2. The vehicle door long gun holder of claim 1 including a soft flexible strap attached to or wrapped around the elongated thin of section, the strap can be a loop which opens or closes and is secured to itself by securing means.

3. The vehicle door long gun holder of claim 2 further including attachment of the flexible strap to the elongated thin section through sliding means.

4. The vehicle door long gun holder of claim 1 including two soft flexible straps attached to or wrapped around the elongated thin of section, the straps can be loops which open or close and secure to themselves by securing means.

5. The vehicle door long gun holder of claim 4 further including attachment of the flexible straps to the elongated thin section through sliding means.

6. The vehicle door long gun holder of claim 1 further including attachment of the fasteners to elongated thin section through pivotal means.

7. The vehicle door long gun holder of claim 6 further including a variety of linear slots running the long direction on the elongated thin section where the fasteners may attach anywhere along the slots.

8. The vehicle door long gun holder of claim 1 further including attachment of the fasteners and rests by a removable means.

9. The vehicle door long gun holder of claim 1 further including the attachment of the rests through pivotal means.

10. A vehicle door long gun holder designed to rest diagonally on the inside of a vehicle door, comprising:
a) an ridged pole of appropriate length,
b) located along the pole are two fasteners one of which rests on the vehicles door's handle and the other fastener rests on the lower cubby slot of the vehicles door,
c) opposite the fasteners and attached to the pole are two rests, one for the arm of the long gun and one for the butt of the long gun,
d) wrapped around or attached to the pole are multiple soft flexible straps, the straps can be loops which open or close and secure to themselves by securing means.
whereby, a user can rest the long gun holder on the inside of a vehicle door without hard fastening the holder to the door.

11. A vehicle door long gun holder as in claim 10 further including the fasteners rests, and straps are attached to the pole through removable and slideable means.
